(19) United States
(12) Patent Application Publication
(10) Pub. No.: US 2015/0219511 A1
(43) Pub. Date: Aug. 6, 2015

(54) Method And Device For Evaluating Door Closing Performance

(71) Applicant: Tom Van Esch, Waterford, MI (US)

(72) Inventor: Tom Van Esch, Waterford, MI (US)

(21) Appl. No.: 14/612,573

(22) Filed: Feb. 3, 2015

Related U.S. Application Data
(60) Provisional application No. 61/934,978, filed on Feb. 3, 2014.

(51) Int. Cl. G01L 3/24

(52) U.S. Cl. CPC G01L 3/24

(57) ABSTRACT

A device and method are disclosed for evaluating closing performance of a door in which the door engages an engagement element included in the device which is detachably mounted to fixed structure adjacent the door and which is moved by an opening movement of the door. An elastic element such as a spring is deflected by the motion of the engagement element to generate elastic potential energy which is detected and shown by a detector/display so that the point of release of the door is determined when the potential energy reaches that corresponding to a predetermined minimum mechanical energy level. The door is then swung in a closing direction by the potential energy stored in the elastic element and it can be immediately determined if the door closure performance is met by the door becoming fully closed.

### CROSS REFERENCE TO RELATED APPLICATIONS

This application claims the benefit of U.S. Ser. No. 61/934,978 filed on Feb. 3, 2014.

### BACKGROUND OF THE INVENTION

The present invention relates to evaluating door closing performance and in particular the mechanical energy applied to displace a door from an open to a closed position in that evaluation.

When an automotive door system is developed, a requirement is typically set that the door system should close when a predetermined minimum level of energy is applied since this affects the impression of quality to a potential customer for the car on which the door is installed. This standard is very common in automotive production.

The standard approach has been to measure the closing speed of the door which results when the door is pushed by an inspector when attempting to manually close the door by pushing the door at an approximate minimum manual closing speed and repeating the closing until a predetermined minimum door speed has been achieved. If the door successfully closes at that speed, the door passes the test.

However, given the high production rate typical in the automotive field, the evaluation of the closing performance such door system is difficult to carry out in that manner is not satisfactory as it is time consuming to carry out several tries and also is not sufficiently accurate. That is because the production inspector must often do several to achieve even approximately the minimum predetermined speed of the door when manually pushing it towards the closing position to be able to observe the result.

Inspectors are heretofore not able to push the door in a closing direction the door at an exact desired speed.

Also, being a manual process, the accuracy of the measurements is uncertain. Thus, commercially available testing arrangements have not been capable of quickly carrying out an inspection.

It is known that a good measure of closing performance is a minimum mechanical energy applied to the door. However, one difficulty in applying such mechanical energy to the door that this energy is not equal to the kinetic energy of the door developed by being pushed closed as the kinetic energy results from other forces also applied to the door such as the force of gravity.

The desired energy applied has to be that resulting solely from the force applied to the door in closing it.

It is the object of the present invention to provide a device and method for accurately applying a predetermined minimum mechanical energy to the door during an attempt to close a door to evaluate door closure performance and to accomplish this evaluation by a single closing of the door which device also enables a quick installation and the removal of the device.

### SUMMARY OF THE INVENTION

The above recited object and other objects which will be understood by those skilled in the art are achieved by a device which allows an inspector to quickly set and apply a predetermined minimum level of mechanical energy to a door in order to attempt to close the same and thereby determine door closure if the door closure performance is acceptable by observing if door closure is obtained with that level of mechanical energy.

The device includes an engagement element mounted to an adjacent fixed structure so as to be positioned to be engaged by the door when it is swung open manually by an inspector.

The engagement element is moved with the door in undergoing its opening motion after the engagement elements' engagement with the door, which movement of the engagement element causes resilient deflection of an elastic element, which deflection develops an elastic potential energy which is progressively increased as the door opening motion continues by the manual effort of the inspector.

A detection/display device continuously monitors and displays the magnitude of the elastic potential energy level generated so that the inspector can determine precisely when a predetermined energy level has been developed. At this point, the opening door motion is stopped and the door is then simply released by the inspector who can observe if closure is achieved by the application of that level of mechanical energy.

The inspector need only note whether closure is achieved or not to complete the door closure evaluation.

The resiliently deflectable elastic element may comprise a linear or rotary mechanical spring which is deflected to generate the elastic potential energy.

The device including the engagement element, the elastic element and the detector/display are removably mounted to the adjoining fixed structure as by a suction cup so as to be able to be quickly installed and removed as a unit from the fixed structure.

### DESCRIPTION OF THE DRAWINGS

FIG. 1 is a pictorial view of a device according to the present invention installed on fixed structure adjacent a door, shown in a simplified diagrammatic form.

FIG. 2 is a top view of the components shown in FIG. 1.

FIGS. 3A-3C are top diagrammatic views of the components shown in FIG. 2 at successive stages of the method according to the invention.

### DETAILED DESCRIPTION

In the following detailed description, certain specific terminology will be employed for the sake of clarity and particular embodiment described in accordance with the requirements of 35 USC 112, but it is to be understood that the same is not intended to be limiting and should not be so construed inasmuch as the invention is capable of taking many forms and variations within the scope of the appended claims.

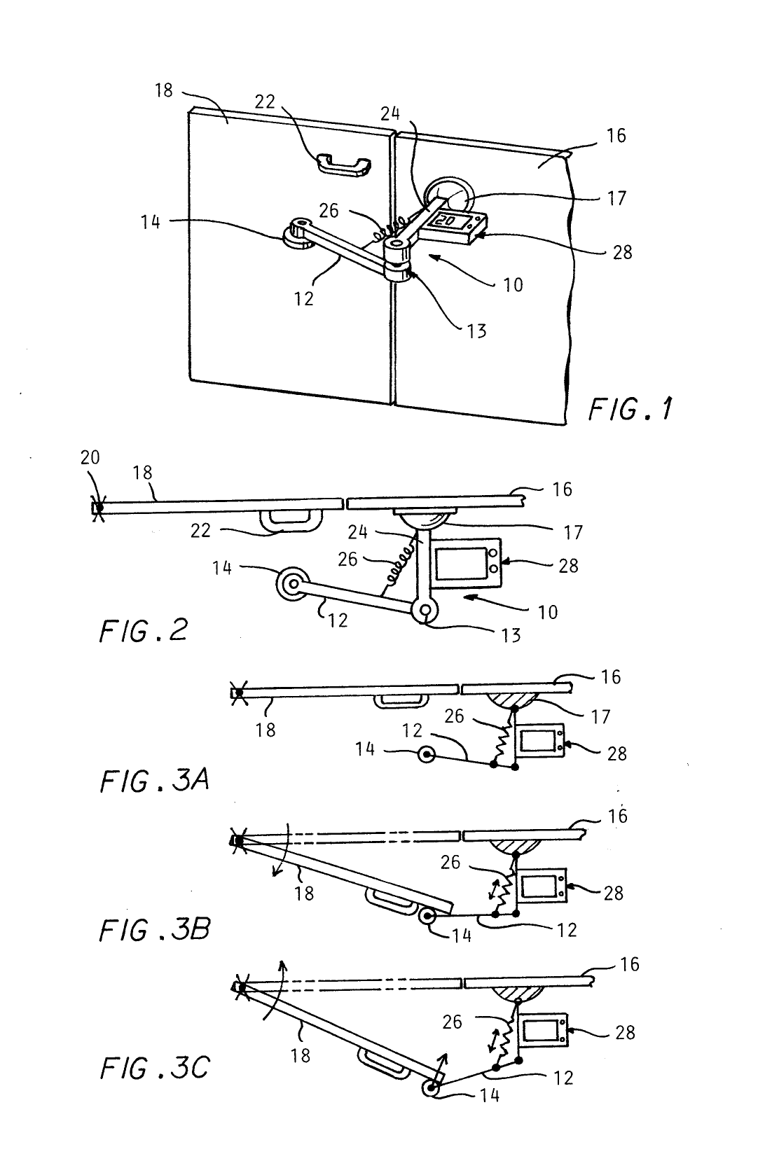

FIG. 1 shows a device 10 that includes a lever arm 12 and a door engagement element comprised of a roller 14 rotatably mounted at the outer end of the lever arm 12.

The device 10 is temporarily mounted to a fixed structure 16 adjacent a door 18 to be evaluated which is hinged at 20 (FIG. 2). The door 18 has a handle 22 for manually opening and closing (components of the conventional door closure mechanism are not shown).

The lever arm 12 has a pivot connection 13 at the end opposite the roller 14 pivotally connecting it to a standoff stanchion 24 held extending generally perpendicularly away from the fixed structure 16 and door 18.

This allows the lever arm 12 to swing and be positioned opposite the door 18 so that the engagement element roller 14 is contacted by the door 18 as it is swung open.

The roller 14 thereafter is moved in unison with the door 18, swinging about pivot connection 13. This motion is resisted by a resiliently deflectable elastic element here shown as tension spring 26 which generates a progressively increasing resistance force by being stretched out as the roller 14 is moved outwardly by the door 18 while being swung out in an opening direction.

This develops an elastic potential energy stored in the spring 26. The level of this elastic potential energy of each position of the door in its outward swinging motion is detected by a detector/display 28 mounted on the stanchion arm 24 to be readily viewable by the inspector as he or she manually swings the door 18 out in the opening direction as indicated in FIG. 3B.

The minimum level of the mechanical energy to be applied has been predetermined during the design of the door system, such that the operator can precisely set the elastic potential energy by swinging the door out until that minimum elastic energy level is developed as shown by the detector/display 28.

At that point, the door 18 is simply released by the inspector, allowing the door 18 to be swung back towards the closed position by the stored mechanical energy developed in the spring 26.

To complete the door closures evaluation, the operator need only observe whether or not the door is successfully closed by the elastic potential energy, and if so the door system passes, and if not, it fails the test.

The device 10 may then be quickly removed.

Thus, only a single short test is necessary to complete a closure performance evaluation and highly accurate results are thereby achieved.

The device can be mounted on a fixed structure adjacent to the door. An arm, extension or lever will initially be floating over the door panel. When opening the door the door panel will push against the lever.

The spring that is compressed or tensioned can be of a linear or a rotational nature, i.e., regular coil spring or torsion spring, etc.

To avoid scratching or rubbing roller 14 on the lever arm 12 can have smooth surface that is able to transfer the force on the lever arm 12 to the door.

The rate characteristics of the spring 26 can be used to determine the force level or an additional torque measurement unit (not shown) can determine the potential energy generated.

An additional display (digital or pointer) can shown the displacement or angle lever arm 12.

For additional accuracy a rotary encoder (not shown) could be used to determine the exact angular or linear displacement of the lever arm.

The unit can be also equipped with a small electronic processor (not shown) capable of calculating the plastic potential energy based on the force and displacement or torque and angle.

Any method of display, analog or digital, will inform the inspector at any time how much energy about to be released to attempt to close the door thus the inspector can simply pull the door open to a given nominal value of stored elastic energy, release the door and observe if the door has travelled to its closed position.

After the door 18 has closed (or stopped) the inspector may confirm the status of the door closure using a button or similar to confirm the reading.

1. A method for determining if a predetermined minimum level of mechanical energy will completely close a hinged door comprising:
disposing an engagement element so as to be contacted by said door as said door is swung out in an opening direction under the control of an inspector, said engagement element continued to be moved thereafter by continuing the movement of said door in an opening direction;
creating a corresponding increasing potential energy as said movement of said engagement element proceeds after said door contacts said engagement element by generating an elastic resistance to said movement to create elastic potential energy which acts on said door through said engagement element upon release of said door to move said door towards a closed position;
determining and displaying the level of elastic potential energy created as said door is swung open against the elastic resistance thereto to allow an inspector to observe when said predetermined minimum level of mechanical energy corresponding to said elastic potential energy has been reached, and thereafter releasing said door to allow said door to be swung towards a closed position solely by the effect thereon of said elastic potential energy; and
observing if said door is thereafter completely closed or not completely closed thereby determining if said predetermined mechanical minimum energy has or has not achieved complete closure of said door.

2. The method according to claim 1 wherein said engagement element is releasably mounted to fixed structure adjacent said door at a location whereby said engagement element is engaged by said door as said door swings toward an open position.

3. The method according to claim 2 wherein said engagement element is releasably attached to said fixed structure by a suction cup.

4. The method according to claim 1 wherein creating stored energy is carried out by causing progressive deformation of a resiliently deflectable element as said engagement element is moved out by said opening motion of said door.

5. A device for generating an increasing elastic potential energy on a hinged door as said door is swung in an opening direction, comprising:
an engagement element and amounting therefore to fixed structure adjacent a free side of said door, said engagement element located thereby over said door at a position, so as to be engaged by said door by opening swinging motion of said door, said mounting allowing movement of said engagement element on said mounting during said opening swinging motion of said door;
said movement of said engagement element with said door resisted by a resiliently deflectable elastic element included in an elastic potential energy generating arrangement associated with said engagement element; and
said elastic potential arrangement including an energy determining component determining the total elastic potential energy generated by movement of said door during opening movement thereof after engagement with said engagement element and an associated display corresponding to said elastic potential energy generated to enable an inspector to determine when to release said door in order to impart a predetermined elastic potential energy to said door to swing said door back towards said closed position and to observe whether or not said elastic potential energy will completely close said door.

6. The device according to claim 5 wherein said engagement element is pivotally mounted on said fixed structure and is pivoted as said door is swung open, said elastic element deflected by said pivoting motion of said engagement element to generate said elastic potential energy.

7. The device according to claim 6 wherein said elastic element comprises a spring deflected by said pivoting motion of said engagement element and generating said elastic potential energy.

8. The device according to claim 5 wherein said mounting includes a suction cup engaged with said fixed structure to mount said engagement element on said fixed structure.

9. The device according to claim 7 wherein the extent of deflection of said spring is detected and the corresponding elastic potential derived from the sensing of the extent of deflection thereof displayed for viewing of an inspector.
